(19) United States
(12) Patent Application Publication
(10) Pub. No.: US 2026/0350363 A1
(43) Pub. Date: Nov. 5, 2026

(54) LEARNING APPARATUS

(71) Applicant: NEC Corporation, Tokyo (JP)

(72) Inventor: Michimasa IRIE, Tokyo (JP)

(73) Assignee: NEC Corporation, Tokyo (JP)

(21) Appl. No.: 19/487,609

(22) PCT Filed: Jun. 13, 2023
(86) PCT No.: PCT/JP2023/021890

§ 371 Date: Nov. 25, 2025

(51) Int. Cl. G06N 3/0455

(52) U.S. Cl. CPC G06N 3/0455

(57) ABSTRACT

A learning apparatus includes: an extracting unit that performs extraction of a feature vector using a mechanism to distribute the feature vector on a feature space in response to input of a state-action sequence including at least one combination of state and action; and an update unit that updates a prototype, which is a typical example of the state-action sequence, based on the feature vector extracted by the extracting unit.

### TECHNICAL FIELD

The present disclosure relates to a learning apparatus, a learning method, a recording medium, and an inference apparatus.

### BACKGROUND ART

A technique used for inferring an action of an imitation target in accordance with a state is known.

For example, Patent Literature 1 describes an apparatus that infers an action in response to input of a state and outputs a typical example (prototype) used for the inference. For example, in the case of the technique described in Patent Literature 1, the apparatus learns an action sequence to be a typical example (prototype) at the time of learning. Further, at the time of inference, the apparatus acquires a prototype corresponding to a state to be an inference target. Then, the apparatus infers an action based on the state and the prototype. As a result, the apparatus can output the inferred action and output the prototype that is the typical example used at the time of the inference.

### CITATION LIST

### Patent Literature

Patent Literature 1: WO2021/242585

### SUMMARY OF INVENTION

### Technical Problem

According to the technique described in Patent Literature 1, there is a case where only a specific prototype is selected at the time of inference and only the same prototype is output as the basis of inference. Thus, there is a problem that it may be difficult to enable output of a more appropriate basis.

Accordingly, an object of the present disclosure is to provide a learning apparatus, learning method, recording medium, and inference apparatus that can solve the abovementioned problem.

### Solution to Problem

In order to achieve the object, a learning apparatus of the present disclosure includes: an extracting unit configured to perform extraction of feature vector using a mechanism to distribute the feature vector on a feature space in response to input of a state-action sequence including at least one combination of state and action; and an update unit configured to update a prototype, which is a typical example of the state-action sequence, based on the feature vector extracted by the extracting unit.

Further, a learning method of the present disclosure is a learning method by an information processing apparatus and includes: performing extraction of a feature vector using a mechanism to distribute the feature vector on a feature space in response to input of a state-action sequence including at least one combination of state and action; and updating a prototype, which is a typical example of the state-action sequence, based on the extracted feature vector.

Further, a recording medium of the present disclosure is a non-transitory computer-readable recording medium with a program recorded thereon, and the program includes instructions for causing an information processing apparatus to enable processes to: perform extraction of a feature vector using a mechanism to distribute the feature vector on a feature space in response to input of a state-action sequence including at least one combination of state and action; and update a prototype, which is a typical example of the state-action sequence, based on the extracted feature vector.

Further, an inference apparatus of the present disclosure includes: an acquiring unit configured to acquire a prototype learned using a mechanism to distribute a feature vector on a feature space in accordance with a state to be inference target; an inference unit configured to infer an action based on the state to be inference target and the prototype acquired by the acquiring unit; and an output unit configured to output the action inferred by the inference unit and the prototype used in inference.

### Advantageous Effects of Invention

With the configurations as described above, it is possible to enable output of a more appropriate basis.

### BRIEF DESCRIPTION OF DRAWINGS

FIG. 1 is a diagram showing the overview of an inference apparatus in the present disclosure.

FIG. 2 is a block diagram showing an example of the configuration of the inference apparatus according to the present disclosure.

FIG. 3 is a diagram for describing an example of a state-action sequence.

FIG. 4 is a diagram showing an example of option selection.

FIG. 5 is a diagram showing an example of division of the state-action sequence.

FIG. 6 is a diagram for describing an example of a feature extraction process.

FIG. 7 is a diagram for describing an example of the feature extraction process.

FIG. 8 is a diagram for describing an example of the feature extraction process.

FIG. 9 is a diagram for describing an example of the feature extraction process.

FIG. 10 is a diagram for describing an example of a prototype update process.

FIG. 11 is a diagram for describing an example of the prototype update process.

FIG. 12 is a diagram for describing an example of the prototype update process.

FIG. 13 is a diagram showing an example of output.

FIG. 14 is a flowchart showing an example of the operation at the time of learning.

FIG. 15 is a flowchart showing an example of the operation at the time of inference.

FIG. 16 is a diagram showing an example of a feature vector.

FIG. 17 is a diagram showing an example of the feature vector.

FIG. 18 is a diagram showing an example of the hardware configuration of a learning apparatus according to the present disclosure.

FIG. 19 is a block diagram showing an example of the configuration of the learning apparatus.

FIG. 20 is a flowchart showing an example of the operation of the learning apparatus.

FIG. 21 is a block diagram showing an example of the configuration of a second inference apparatus according to the present disclosure.

### EXAMPLE EMBODIMENT

### First Example Embodiment

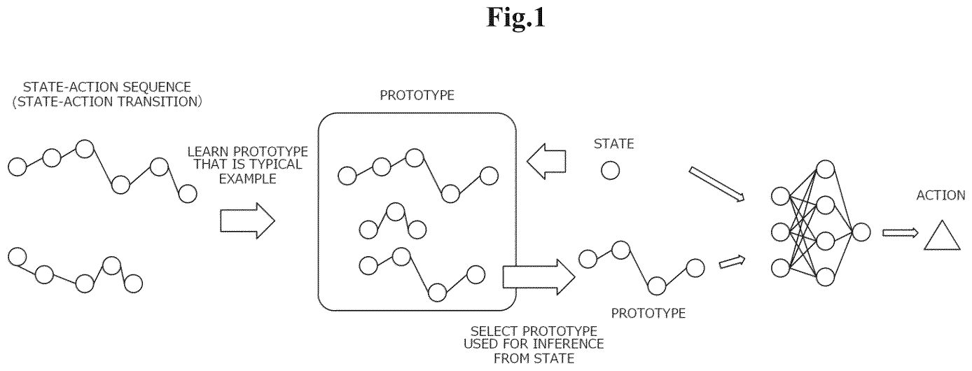

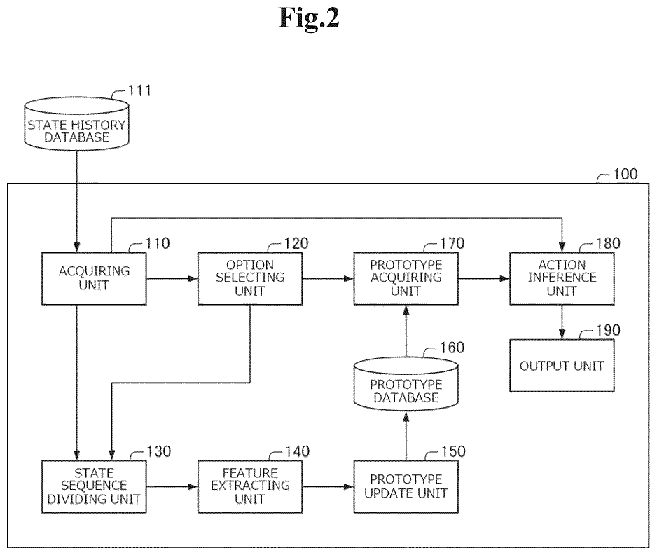

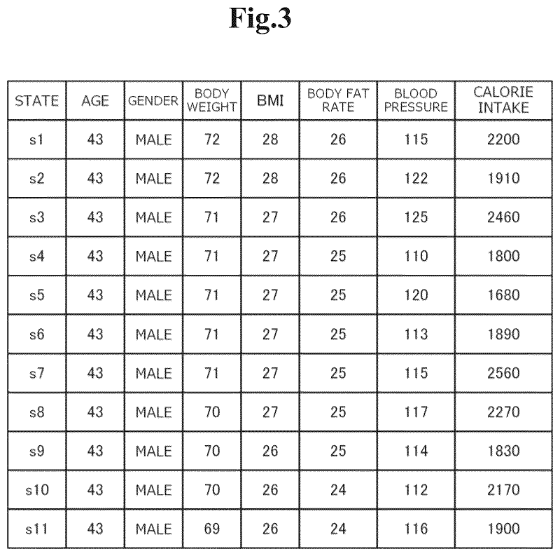

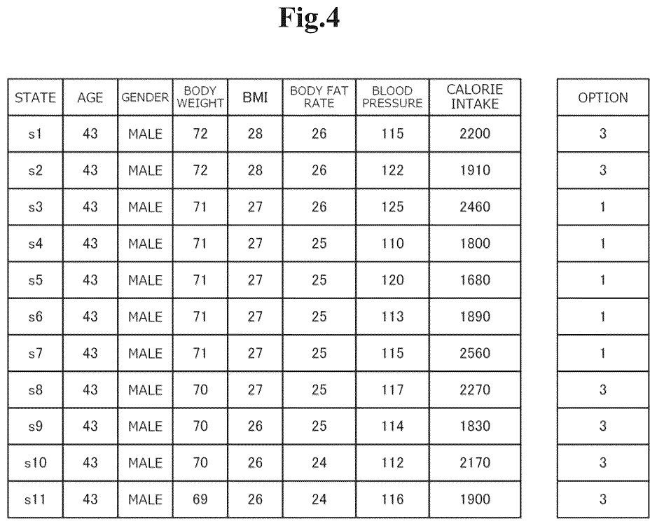

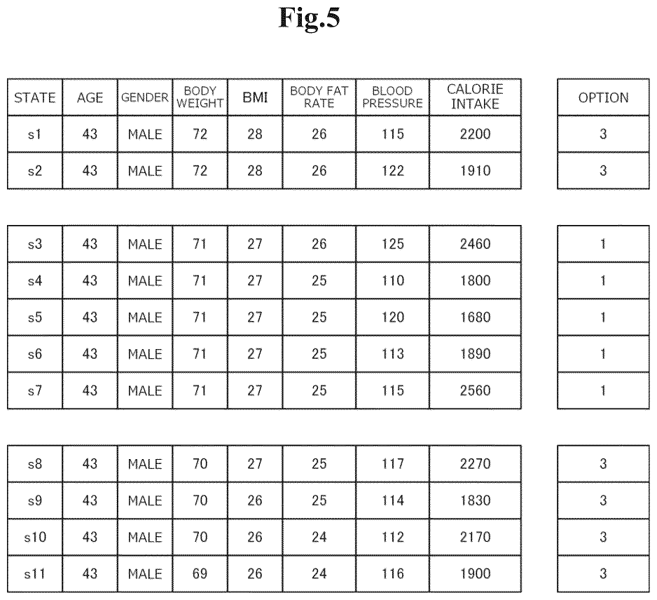

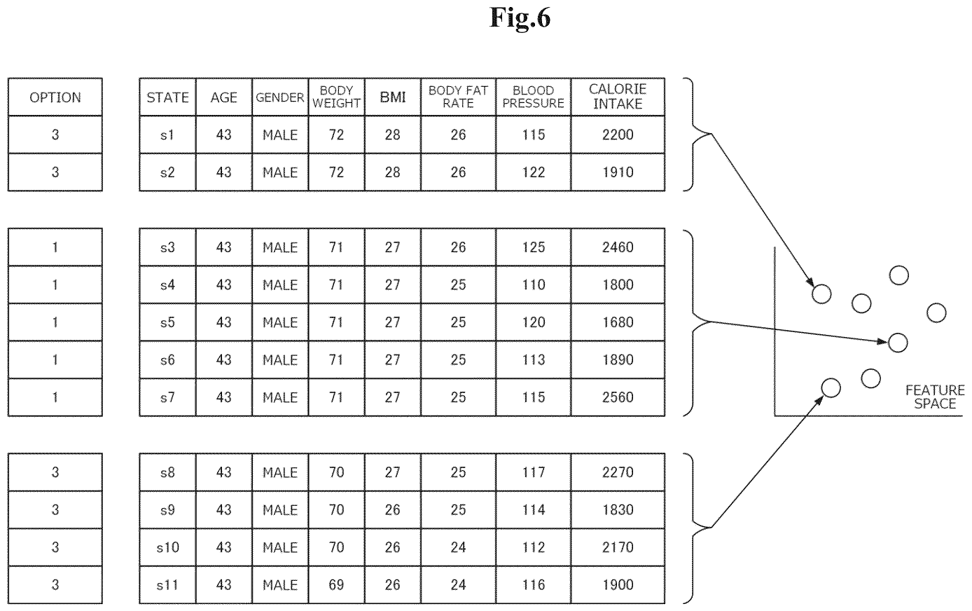

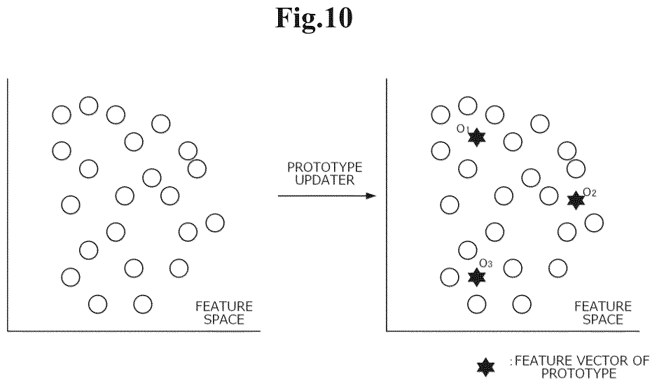

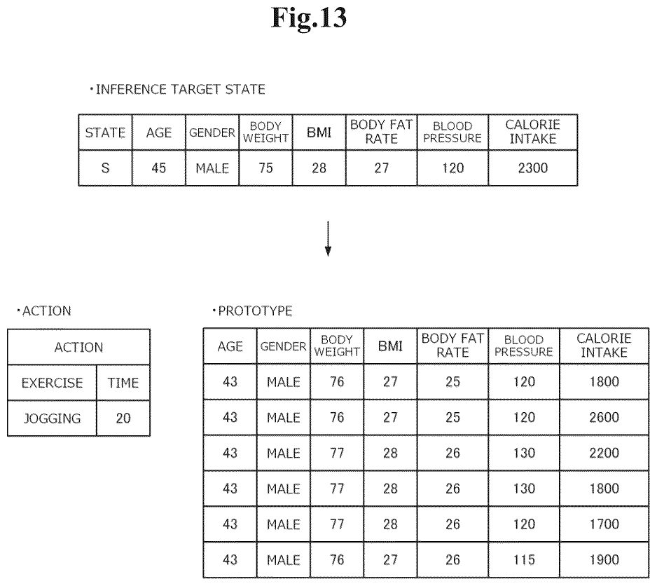

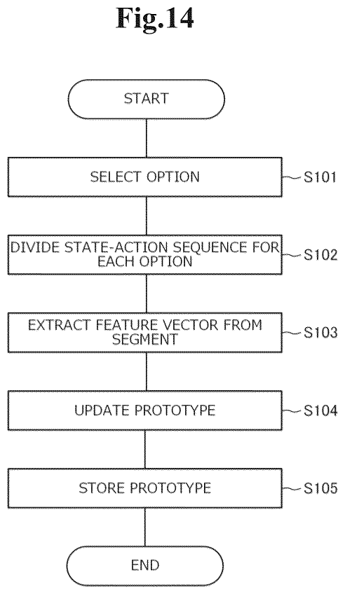

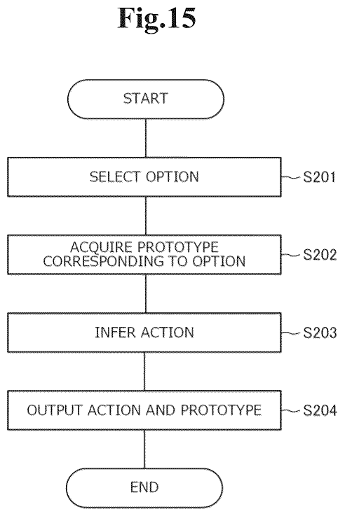

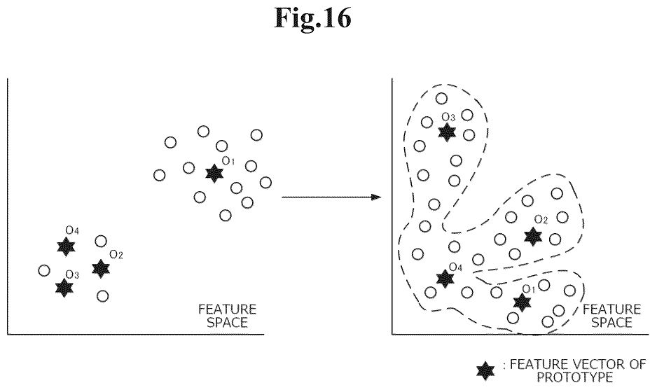

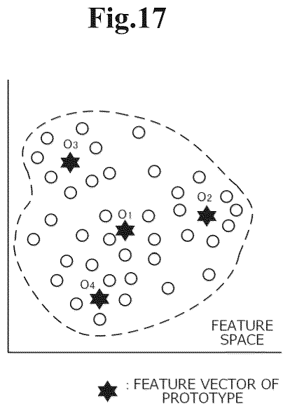

An example of the configuration of a first inference apparatus 100 according to the present disclosure will be described with reference to FIGS. 1 to 17. FIG. 1 is a diagram showing the overview of the inference apparatus 100. FIG. 2 is a block diagram showing an example of the configuration of the inference apparatus 100. FIG. 3 is a diagram for describing an example of a state-action sequence. FIG. 4 is a diagram showing an example of option selection. FIG. 5 is a diagram showing an example of division of the state-action sequence. FIGS. 6 to 9 are diagrams for describing an example of a feature extraction process. FIGS. 10 to 12 are diagrams for describing an example of a prototype update process. FIG. 13 is a diagram showing an example of output. FIG. 14 is a flowchart showing an example of the operation at the time of learning. FIG. 15 is a flowchart showing an example of the operation at the time of inference. FIGS. 16 and 17 are diagrams showing an example of a feature vector. In the present disclosure, the drawings may be associated with one or more example embodiments.

In a first example embodiment of the present disclosure, the inference apparatus 100 (learning apparatus), which is an information processing apparatus that infers an action in response to input of a state will be described. For example, as shown in FIG. 1, at the time of learning, the inference apparatus 100 previously performs learning (machine learning) of prototypes to be typical examples based on a state-action sequence showing the transition of state and action. Further, at the time of inference, the inference apparatus 100 acquires a prototype corresponding to a state to be an inference target. Then, the inference apparatus 100 infers an action based on the state and the prototype. After that, the inference apparatus 100 can output the inferred action and also output the prototype that is the typical example used at the time of inference.

Further, at the time of learning a prototype, the inference apparatus 100 described in the present disclosure performs the abovementioned learning by extracting feature vectors by using an architecture having a mechanism to distribute feature vectors on a feature space. For example, the inference apparatus 100 performs the abovementioned extraction by using an architecture of an autoencoder including an encoder that receives input of a state-action sequence and obtains a feature vector and a decoder that receives input of the feature vector and reconstructs the state-action sequence. According to such a configuration, feature vectors are distributed on a feature space. Therefore, it is also possible to distribute the feature vectors of the prototypes to be updated in accordance with the extracted feature vectors. Consequently, at the time of inference, the inference apparatus 100 can select an appropriate prototype without selecting only a specific prototype.

The inference apparatus 100 described in the present disclosure can be used, for example, for inferring and imitating an action of an imitation target such as a specialist and other experts. For example, the inference apparatus 100 can be used for retail-related inference and decision-making assistance, such as inferring an action that an inference target person should take from the state and action of a good customer and recommending a necessary action to perform the inferred action. Moreover, the inference apparatus 100 may be used for healthcare-related applications, such as inferring and presenting the actions of users who wish to improve their health from the states and actions of users who have shown health improvement effects and thereby assisting on decision-making. In addition to the cases illustrated above, the inference apparatus 100 may be used in any situation to infer an action corresponding a state by machine learning and assist on various decision-making processes.

Further, in the present disclosure, a state refers to data indicating the attribute, condition, situation and so forth of a subject at a given time point. A state can include one or a plurality of values. For example, in the case of healthcare-related applications, a state can include at least some values of values corresponding to age, gender, BMI (Body Weight Index), body fat rate, blood pressure, calorie intake, and dietary content. A state may include a value other than those illustrated above. Further, an action refers to the content, type and so forth of a conduct carried out by a subject in a corresponding state. For example, in the case of healthcare-related applications, an action may include values corresponding to the type and content of an action such as the type, time, and intensity of exercise. In the same manner as a state, an action may also include a value other than those illustrated above. Further, a state-action sequence refers to the transition of state and action, which includes one or a plurality of combinations of a state at a certain time point and an action corresponding to the state. For example, a state-action sequence may be data that chronologically represents the transition of state and action of a certain person. A state-action sequence may chronologically represent the transition of state and action of one or a plurality of persons.

Further, in the present disclosure, a prototype refers to a typical example of the transition of state and action learned from a state-action sequence. A prototype can include one or a plurality of combinations of a state and an action corresponding to the state. Further, in the present disclosure, a subgoal selected by an option selecting unit 120 based on the state and so forth is referred to as an option. For example, an option can be associated with a prototype. Therefore, an option can also be referred to as identification information for identifying a prototype. For example, the number of options may be preset to k (k is a natural number).

FIG. 2 shows an example of the configuration of the inference apparatus 100. Referring to FIG. 2, the inference apparatus 100 includes an acquiring unit 110, an option selecting unit 120, a state-action sequence dividing unit 130, a feature extracting unit 140, a prototype update unit 150, a prototype acquiring unit 170, an action inference unit 180, and an output unit 190. For example, the inference apparatus 100 includes an arithmetic logic unit of a CPU (Central Processing Unit) or the like, and a memory unit storing a program. For example, by reading the program from the memory unit and executing it by the arithmetic logic unit, the inference apparatus 100 can make the above hardware and the program cooperate and implement the above processing units. Moreover, the inference apparatus 100 can include a state history database 111, a prototype database 160, and the like.

FIG. 2 illustrates a case of implementing a function as the inference apparatus 100 by using a single information processing apparatus. However, at least part of the function as the inference apparatus 100 may be implemented by using a plurality of information processing apparatuses, such as being implemented on the cloud, for example. Moreover, the inference apparatus 100 may include a configuration other than illustrated above, for example, an operation input unit such as a keyboard and a mouse, and a screen display device such as a display.

Further, the inference apparatus 100 may include a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The acquiring unit 110 acquires a state-action sequence to be a learning target, a state to be an inference target, and the like. For example, the acquiring unit 110 acquires a state-action sequence to be a learning target, a state to be an inference target, and the like by referring to the state history database 111 storing state-action sequences, and the like.

For example, as illustrated in FIG. 3, the acquiring unit 110 can acquire a state-action sequence including a plurality of states. As an example, in the case illustrated in FIG. 3, the acquiring unit 110 acquires a state-action sequence including 11 states from state s1 to state s11. Further, each of the states from state s1 to state s11 acquired by the acquiring unit 110 includes a plurality of values such as age, gender, and body weight. Although not illustrated in FIG. 3, a state-action sequence may include the value of an action corresponding to each state.

The acquiring unit 110 may acquire a state-action sequence to be a learning target, a state to be an inference target, and the like by a method other than that illustrated above. For example, the acquiring unit 110 may acquire a state-action sequence to be a learning target, a state to be an inference target, and the like by any method such as receiving input using an operation input unit such as a keyboard and a mouse or acquiring it from an external device or the like.

The state history database 111 is a storage device that stores a state-action sequence to be a learning target, and the like. For example, the state history database 111 can include one or a plurality of state-action sequences. As described above, a state-action sequence may include one or a plurality of combinations of a state at a certain time point and an action corresponding to the state. Moreover, the state history database 111 can include a state to be an inference target, and the like. The various information included by the state history database 111 are acquired by any means, such as receiving input using an operation input unit such as a keyboard and a mouse or acquiring it from an external device or the like, and stored in the storage device.

The state history database 111 may be external to the inference apparatus 100 as illustrated in FIG. 2, or may be included by the inference apparatus 100. In the present disclosure, an apparatus including the state history database 111 is not specifically limited.

The option selecting unit 120 selects an option for a state-action sequence to be a learning target, a state to be an inference target, and the like. For example, the option selecting unit 120 can select an option based on the content of a state to be a selection target, and the like, for each state included by a state-action sequence and a state to be an inference target.

FIG. 4 shows an example of option selection by the option selecting unit 120. For example, referring to FIG. 4, the option selecting unit 120 selects an option for each state included by the state-action sequence. As an example, in the case illustrated in FIG. 4, the option selecting unit 120 selects option 3 for states s1 and s2. Further, the option selecting unit 120 selects option 1 from states s3 to s7, and selects option 3 from states s8 to s11.

In the case of the present disclosure, the option selecting unit 120 can perform option selection by using a model that has learned in advance to output an option in response to input of a state. In other words, the option selecting unit 120 may be an option selector that has learned in advance to output an option in response to input of a state. Further, an option selection policy by the option selecting unit 120 may be learned by reinforcement learning or the like. As an example, the option selecting unit 120 can perform reinforcement learning so that as an action inference value by the action inference unit 180 to be described later is closer to the truth value, a higher reward is obtained in policy learning. The option selecting unit 120 may perform policy learning by using a neural network or the like. The option selecting unit 120 may perform learning by using a model other than illustrated.

The state-action sequence dividing unit 130 divides a state-action sequence into a plurality of segments based on an option selected by the option selecting unit 120. Here, a segment refers to a subsequence composed of at least part of a state-action sequence. For example, the state-action sequence dividing unit 130 can divide the state-action sequence for each set of columns in which the option selected by the option selecting unit 120 is consecutive in the state-action sequence.

For example, in the case illustrated in FIG. 4, the option selecting unit 120 selects option 3 for states s1 and s2, selects option 1 for states s3 to s7, and selects option 11 for states s8 to s11. Then, as illustrated in FIG. 5, the state-action sequence dividing unit 130 divides the state-action sequence into three segments: states s1 and s2 for which option 3 is selected, states s3 to s7 for which option 1 is selected, and states s8 to s11 for which option 3 is selected.

The feature extracting unit 140 extracts the state-action sequence divided by each consecutive option by the state-action sequence dividing unit 130 as a feature vector on the feature space. In other words, the feature extracting unit 140 extracts, for each segment divided by the state-action sequence dividing unit 130, a feature vector corresponding to a feature such as the state included in the segment. For example, in the case illustrated in FIG. 5, the state-action sequence is decomposed into three segments by the state-action sequence dividing unit 130. Therefore, the feature extracting unit 140 extracts a feature vector for each of the three segments divided by the state-action sequence dividing unit 130 as illustrated in FIG. 6.

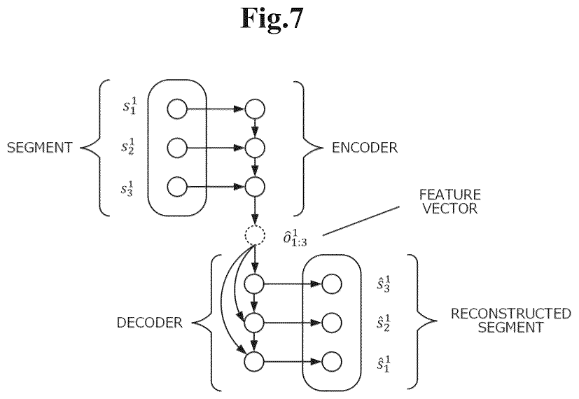

In the present disclosure, the feature extracting unit 140 extracts feature vectors by using an architecture that has a mechanism to distribute feature vectors on the feature space. For example, as illustrated in FIG. 7, the feature extracting unit 140 performs the abovementioned extraction by using an architecture of an autoencoder including an encoder that receives input of a segment constituting at least part of the state-action sequence and obtains a feature vector and a decoder that receives input of the feature vector and reconstructs data of the segment. In other words, the feature extracting unit 140 can calculate a feature vector in response to input of a segment. In a case where an architecture of an autoencoder is used, the feature extracting unit 140 learns a weight parameter or the like so that the data of the input segment is closer to the data of the reconstructed segment. For example, the feature extracting unit 140 can learn the parameters of the encoder and the decoder in such a manner as to minimize a loss function LAE shown by Formula 1. Further, the encoder and the decoder may employ, for example, an architecture of long short-term memory (LSTM).

$${L}_{AE} = {\sum }_{t = 1}^{T} {‖ {\hat{s}}_{t} - {s}_{t} ‖}_{2}^{2} . \qquad [ Formula 1 ]$$

In Formula 2 showing the state in FIG. 7, k is a number given to each state-action sequence, and t is a step number. Further, Formula 3 shows the reconstructed state. Further, vₘ in Formula 4 showing the feature vector indicates a boundary number of a divided step.

$${s}_{t}^{k} \qquad [ Formula 2 ]$$

$${\hat{s}}_{t}^{k} \qquad [ Formula 3 ]$$

$${\hat{o}}_{{v}_{{m}^{′}} : {v}_{m}} \qquad [ Formula 4 ]$$

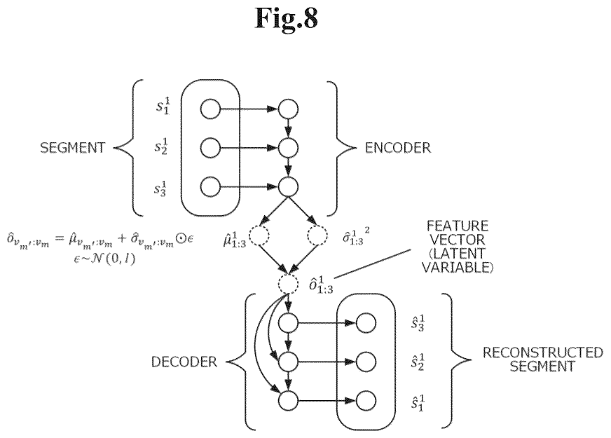

Further, it is more desirable that the feature extracting unit 140 uses a variational autoencoder (VAE) as illustrated in FIG. 8, as the autoencoder. In the case of using a variational autoencoder, the feature extracting unit 140 can calculate the feature vector by obtaining the mean μ and the variance σ2 in response to input of the segment and calculating a latent variable as illustrated in FIG. 8.

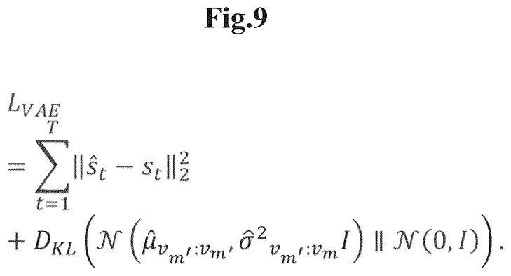

FIG. 9 and Formula 5 illustrate an example of a loss function L_{VAE} when VAE is used. In Formula 5, the former term portion is the same as that of the autoencoder, and the latter term portion is unique to VAE.

$${L}_{VAE} = {\sum }_{t = 1}^{T} {‖ {s}_{t} - {s}_{t} ‖}_{2}^{2} + {D}_{KL} ( 𝒩 ( {\hat{μ}}_{{v}_{{m}^{′}} : {v}_{m}} , {\hat{σ}}_{{v}_{{m}^{′}} : {v}_{m}}^{2} I ) ‖ 𝒩 ( 0 , I ) ) . \qquad [ Formula 5 ]$$

In a case where VAE is used, a standard normal distribution N(0,I) is assumed as the prior distribution of feature vectors shown by Formula 4. For example, the feature vector (Formula 4) when the state shown by Formula 6 is input can be expressed by Formula 7. Here, Formulas 8 and 9 are the mean and variance parameters output by the encoder, respectively.

$${s}_{{v}_{{m}^{′}} : {v}_{m}} \qquad [ Formula 6 ]$$

$$𝒩 ( {\hat{μ}}_{{v}_{{m}^{′}} : {v}_{m}} , {\hat{σ}}_{{v}_{{m}^{′}} : {v}_{m}}^{2} I ) \qquad [ Formula 7 ]$$

$${\hat{μ}}_{{v}_{{m}^{′}} : {v}_{m}} \qquad [ Formula 8 ]$$

$${\hat{σ}}_{{v}_{{m}^{′}} : {v}_{m}}^{2} \qquad [ Formula 9 ]$$

Further, the feature vector (Formula 4) is sampled from the above distribution, and can be obtained from Formula 10 below by using a method called the Reparameterization Trick. Here, ε is a random noise sampled from ε to N(0,I).

$${\hat{o}}_{{v}_{{m}^{′}} : {v}_{m}} = {\hat{μ}}_{{v}_{{m}^{′}} : {v}_{m}} + {\hat{σ}}_{{v}_{{m}^{′}} : {v}_{m}} ⊙ ϵ \qquad [ Formula 10 ]$$

$$ϵ ∼ 𝒩 ( 0 , I )$$

For example, as described above, the feature extracting unit 140 extracts a latent variable as a feature vector by using an encoder in an autoencoder. Further, the feature extracting unit 140 can learn a weight parameter or the like in such a manner that the data of the input segment is closer to the data of the reconstructed segment.

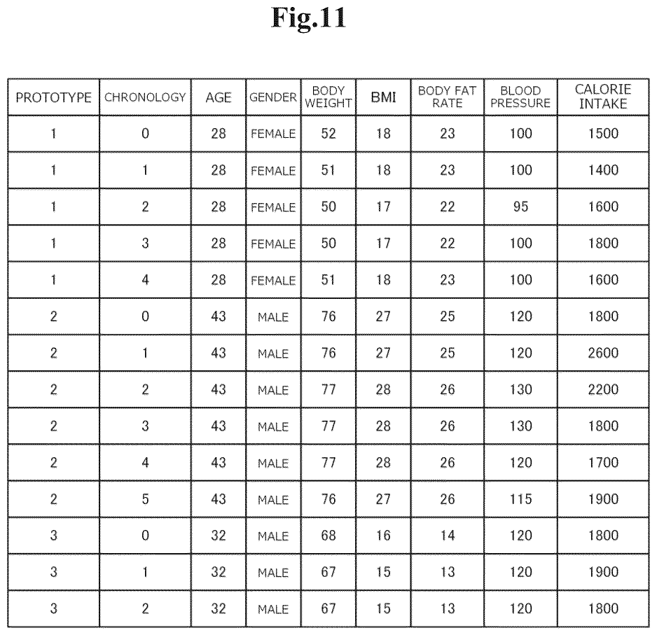

The prototype update unit 150 updates a prototype by using the feature vector extracted by the feature extracting unit 140. For example, as shown in FIG. 10, the prototype update unit 150 can update the feature vector of a prototype in accordance with the result of evaluation using the feature vector extracted by the feature extracting unit 140 and the feature vector of the prototype before the update. Further, the prototype update unit 150 can update the feature vector of the prototype and also update the state-action sequence of the corresponding prototype, as illustrated in FIG. 11. The state-action sequence of the prototype may include data that chronologically represents a state and the transition of state and action. For example, FIG. 11 illustrates data that chronologically represents states and the transitions of state and action corresponding to three prototypes. After that, the prototype update unit 150 stores the state-action sequence, feature vector and the like of the prototype having been updated into the prototype database 160.

As an example, the prototype update unit 150 calculates an update value from a feature vector extracted by the feature extracting unit 140. Then, the prototype update unit 150 can update the feature vector of a prototype in accordance with the calculated update value. Further, the prototype update unit 150 updates the state-action sequence of the prototype based on the updated feature vector. For example, the prototype update unit 150 can specify the state-action sequence of a segment from which the feature vector has been extracted, and update the state-action sequence of the prototype by using a state included by the specified state-action sequence.

In a case where the feature extracting unit 140 uses an architecture of an autoencoder, the prototype update unit 150 may update the feature vector and state-action sequence of a prototype by the same method as the method described in Patent Literature 1 as shown by Formulas 11 and 12.

$${L}_{emb} = {\sum }_{m = 1}^{M} {min}_{k = 1}^{K} {‖ {\hat{o}}_{{v}_{{m}^{′}} : {v}_{m}} - {o}_{k} ‖}_{2}^{2} \qquad [ Formula 11 ]$$

$${L}_{option} = {λ}_{1} * {\sum }_{i = 1}^{K} {min}_{m = 1}^{M} {‖ {\hat{o}}_{{v}_{{m}^{′}} : {v}_{m}} - {o}_{k} ‖}_{2}^{2} + {λ}_{2} * {\sum }_{i = 1}^{K} {\sum }_{j = i + 1}^{K} max ( 0 , {d}_{min} - ‖ {o}_{i} - {o}_{j} ‖ ) \qquad [ Formula 12 ]$$

Note that oₖ is the feature vector of a prototype and k is the number of the prototype.

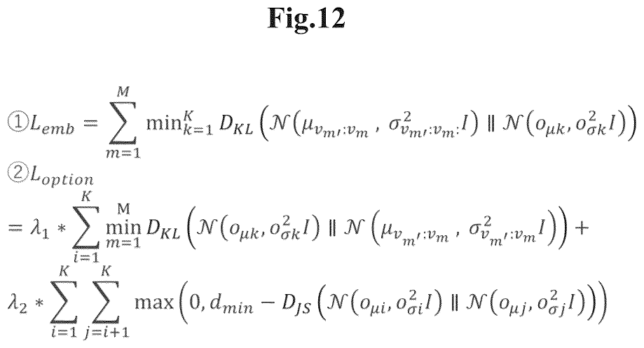

Further, in a case where an architecture of VAE is used, the prototype update unit 150 can update a prototype by using equations shown in FIG. 12 and Formulas 13 and 14 below.

$${L}_{emb} = {\sum }_{m = 1}^{M} {min}_{k = 1}^{K} {D}_{KL} ( 𝒩 ( {μ}_{{v}_{{m}^{′}} : {v}_{m}} , {σ}_{{v}_{{m}^{′}} : {v}_{m}}^{2} I ) ‖ 𝒩 ( {o}_{μ k} , {o}_{σ k}^{2} I ) ) \qquad [ Formula 13 ]$$

$$[ Formula 14 ]$$

$${L}_{option} = {λ}_{1} * {\sum }_{i = 1}^{K} {min}_{m = 1}^{M} {D}_{KL} ( 𝒩 ( {o}_{μ k} , {o}_{σ k}^{2} I ) ‖ 𝒩 ( {μ}_{{v}_{{m}^{′}} : {v}_{m}} , {σ}_{{v}_{{m}^{′}} : {v}_{m}}^{2} I ) ) + {λ}_{2} * {\sum }_{i = 1}^{K} {\sum }_{j = i + 1}^{K} max ( 0 , {d}_{min} - {D}_{JS} ( 𝒩 ( {o}_{μ i} , {o}_{σ i}^{2} I ) ‖ 𝒩 ( {o}_{μ j} , {o}_{σ j}^{2} I ) ) )$$

Note that o_{μk} denotes the mean of the feature vectors of prototypes, and o_{σk} denotes the variance of the feature vectors of the prototypes.

For example, by learning in such a manner that the feature vectors of the segments are closer to the prototypes by using the methods as described above, cluster structure can be promoted. Further, by learning in such a manner that each prototype is closer to the feature of the closest segment, interpretability as a prototype can be enhanced. Further, by learning in such a manner as to increase the distance when prototypes are close to each other, diversity can be increased.

The prototype database 160 is a storage device that stores the feature vector, state-action sequence and the like of a prototype updated by the prototype update unit 150. In the prototype database 160, an option may be associated with the feature vector, state-action sequence and the like of a prototype. For example, the prototype database 160 is updated in response to the prototype update performed by the prototype update unit 150.

The prototype database 160 may be included by the inference apparatus 100 as illustrated in FIG. 2, or may be external to the inference apparatus 100. In the present disclosure, an apparatus including the prototype database 160 is not specifically limited.

The prototype acquiring unit 170 acquires a prototype corresponding to a state to be an inference target in accordance with the result of selection by the option selecting unit 120 with respect to the state to be the inference target. For example, the prototype acquiring unit 170 acquires the feature vector of a prototype associated with an option selected by the option selecting unit 120 by referring to the prototype database 160. The prototype acquiring unit 170 may acquire the state-action sequence of a prototype together with the feature vector of the prototype by referring to the prototype database 160.

The action inference unit 180 infers an action based on a state to be an inference target and the feature vector of a prototype acquired by the prototype acquiring unit 170.

For example, the action inference unit 180 may infer an action by using a model that has learned in advance to output an action in response to input of a state to be an inference target and the feature vector of a prototype. The processing by the action inference unit 180 may be the same as the technique described in Patent Literature 1.

The output unit 190 outputs the result of inference by the action inference unit 180. For example, as shown in FIG. 13, the output unit 190 can output the action inferred by the action inference unit 180, the prototype used for the inference, and the like. The output unit 190 may output the feature vector and the like of the prototype in addition to the state-action sequence of the prototype. For example, the output unit 190 may display the inferred action and the like on a screen display device or transmit to an external device or the like. For example, the output unit 190 outputs the prototype used for inference together with the result of inference, thereby enabling presentation of the determination basis and enabling assistance on more accurate decision-making.

The above is an example of the configuration of the inference apparatus 100. Subsequently, an operation example of the inference apparatus 100 will be described with reference to FIGS. 14 and 15.

FIG. 14 shows an example of the operation of the inference apparatus 100 during prototype updating. Referring to FIG. 14, the option selecting unit 120 selects an option for a state-action sequence to be a learning target (step S101). For example, the option selecting unit 120 can select an option for each state included in a state-action sequence based on the content of a state to be a selection target.

The state-action sequence dividing unit 130 divides the state-action sequence into a plurality of segments based on the options selected by the option selecting unit 120 (step S102). For example, the state-action sequence dividing unit 130 divides the state-action sequence for each set of columns in which the option selected by the option selecting unit 120 is consecutive in the state-action sequence.

The feature extracting unit 140 extracts the state-action sequence divided for each consecutive option by the state-action sequence dividing unit 130, as a feature vector on a feature space (step S103). In the case of the present disclosure, the feature extracting unit 140 performs feature vector extraction using an architecture that has a mechanism to distribute the feature vectors on the feature space. For example, the feature extracting unit 140 performs the abovementioned extraction using an architecture of an autoencoder including an encoder that receives input of a segment constituting part of the state-action sequence and obtains a feature vector and a decoder that receives input of the feature vector and reconstructs the data of the segment.

The prototype update unit 150 updates a prototype using the feature vector extracted by the feature extracting unit 140 (step S104). For example, the prototype update unit 150 can update the feature vector of a prototype and also update the state-action sequence of the corresponding prototype.

Further, the prototype update unit 150 stores the updated feature vector and state-action sequence of the prototype into the storage device as the prototype database 160 (step S105).

The above is an example of the operation of the inference apparatus 100 during prototype updating. Subsequently, an example of the operation of the inference apparatus 100 during action inference will be described with reference to FIG. 15.

FIG. 15 shows an example of the operation of the inference apparatus 100 during action inference. Referring to FIG. 15, in response to acquisition of a state to be an inference target by the acquiring unit 110, the option selecting unit 120 selects an option for the state to be the inference target (step S201).

The prototype acquiring unit 170 acquires a prototype corresponding to the state to be the inference target in accordance with the result of selection for the state to be the inference target by the option selecting unit 120 (step S202). For example, the prototype acquiring unit 170 acquires the feature vector of a prototype associated with the option selected by the option selecting unit 120 by referring to the prototype database 160.

The action inference unit 180 infers an action based on the state to be the inference target and the feature vector of the prototype acquired by the prototype acquiring unit 170 (step S203). For example, the action inference unit 180 may perform action inference using a model that has learned in advance to output an action in response to input of a state to be an inference target and the feature vector of a prototype.

The output unit 190 outputs the result of inference by the action inference unit 180 (step S204). For example, the output unit 190 can output the action inferred by the action inference unit 180, the prototype used for inference, and so forth.

The above is an example of the operation of the inference apparatus 100 during action inference.

Thus, the inference apparatus 100 includes the feature extracting unit 140 and the prototype update unit 150. According to such a configuration, the feature extracting unit 140 can perform feature vector extraction using an architecture that has a mechanism to distribute feature vectors on a feature space. As a result, the prototype update unit 150 can perform prototype updating using the feature vectors extracted in such a manner as to be distributed by the feature extracting unit 140. That is to say, according to the above configuration, it is possible to distribute the feature vectors of a prototype to be updated in accordance with the extracted feature vectors. Consequently, by use of the prototypes updated by the prototype update unit 150, it is possible to select an appropriate prototype without selecting only a specific prototype during inference. As a result, for example, when assisting on various decision-making by inferring an action corresponding to a state by machine learning, it is possible to enable more appropriate assistance.

For example, FIG. 16 shows an example of feature vector extraction using the technique described in Patent Literature 1, and an example of feature vector extraction by the feature extracting unit 140 using an architecture having a mechanism to distribute feature vectors on a feature space. In the case illustrated in FIG. 16, an example of a feature space when the technique described in Patent Literature 1 is used is shown on the left side, and an example of a feature space when feature vectors are extracted using the feature extracting unit 140 is shown on the right side. Referring to FIG. 16, it can be understood that by extracting feature vectors using the feature extracting unit 140, the features of the state-action sequence can be better grasped, thereby making it less likely for the feature vectors to concentrate into one.

Further, FIG. 17 shows an example of a feature space when VAE is used.

Referring to FIG. 17, by adding normalization by VAE and constraining the representation, it is possible to further suppress the concentration of the distribution within the feature space. Consequently, it can be understood that the concentration of feature vectors can be suppressed more.

### Second Example Embodiment

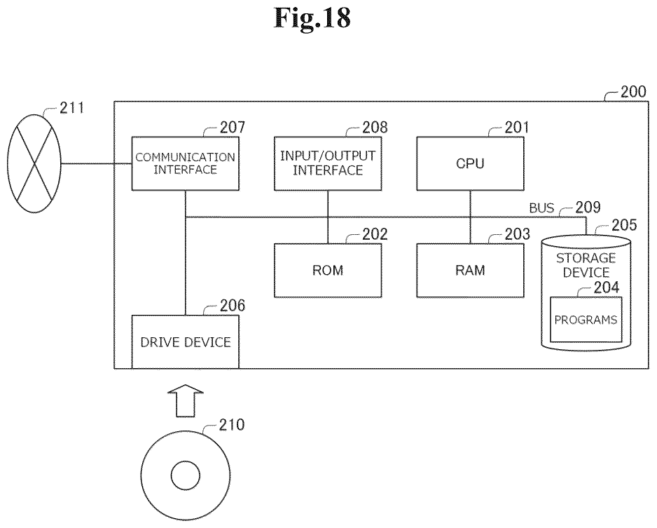

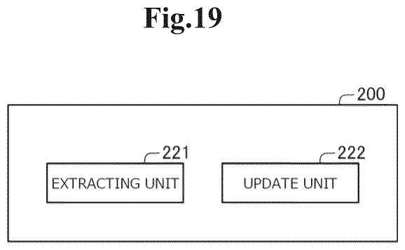

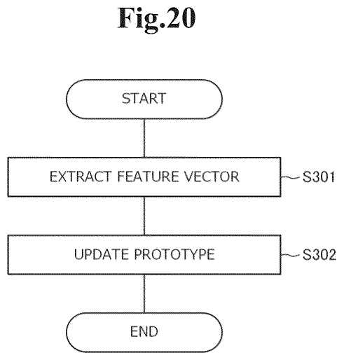

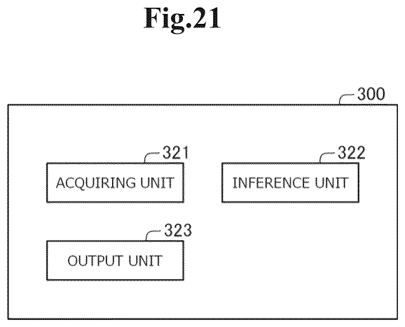

Next, a learning apparatus 200 and an inference apparatus 300 will be described with reference to FIGS. 18 to 21. FIG. 18 is a diagram showing an example of a hardware configuration of the learning apparatus 200. FIG. 19 is a block diagram showing an example of the configuration of the learning apparatus 200. FIG. 20 is a flowchart showing an example of the operation of the learning apparatus 200. FIG. 21 is a block diagram showing an example of the configuration of the inference apparatus 300.

In the second example embodiment of the present disclosure, the learning apparatus 200 that learns a prototype to be a typical example based on a state-action sequence representing the transition of state and action will be described. Further, in the present disclosure, the inference apparatus 300 that performs inference using the result of learning by the learning apparatus 200 will be described. FIG. 18 shows an example of a hardware configuration of the learning apparatus 200. Referring to FIG. 18, as an example, the learning apparatus 200 has the following hardware configuration including:
a CPU (Central Processing Unit) 201 (arithmetic logic unit);
a ROM (Read Only Memory) 202 (memory unit);
a RAM (Random Access Memory) 203 (memory unit);
programs 204 loaded into the RAM 203;
a storage device 205 storing the programs 204;
a drive device 206 that performs reading from and writing into a recording medium 210 external to an information processing apparatus;
a communication interface 207 connected to a communication network 211 external to the information processing apparatus;
an input/output interface 208 that performs input/output of data; and
a bus 209 connecting the components.

Further, the learning apparatus 200 can implement functions as an extracting unit 221 and an update unit 222 shown in FIG. 19 by acquisition and execution of the programs 204 by the CPU 201. The programs 204 are, for example, stored in advance in the storage device 205 or the ROM 202, and are loaded into the RAM 203 or the like and executed by the CPU 201 as necessary. Moreover, the programs 204 may be provided to the CPU 201 via a communication network 211, or the programs may be stored in advance in a recording medium 210 and read out by the drive device 206 and provided to the CPU 201.

FIG. 18 shows an example of the hardware configuration of the learning apparatus 200. The hardware configuration of the learning apparatus 200 is not limited to the abovementioned case. For example, the learning apparatus 200 may be configured with part of the abovementioned configuration, such as not having the drive device 206. Moreover, the CPU 201 may be a GPU or the like illustrated in the first example embodiment.

The extracting unit 221 performs feature vector extraction using a mechanism to distribute feature vectors on a feature space in response to input of a state-action sequence including at least one combination of state and action. For example, the extracting unit 221 performs feature vector extraction using a mechanism of an autoencoder including an encoder that receives input of a state-action sequence and obtains feature vectors and a decoder that receives input of the feature vectors and reconstructs the state-action sequence.

The update unit 222 updates a prototype that is a typical example of the state-action sequence based on the feature vector extracted by the extracting unit 221. The update unit 222 may store the updated result into the storage device or the like. The above is an example of the configuration of the learning apparatus 200. Subsequently, an example of the operation of the learning apparatus 200 will be described with reference to FIG. 20.

FIG. 20 shows an example of the operation of the learning apparatus 200. Referring to FIG. 20, the extracting unit 221 performs feature vector extraction using a mechanism to distribute feature vectors on a feature space in response to input of a state-action sequence including at least one combination of state and action (step S301). For example, the extracting unit 221 performs feature vector extraction using a mechanism of an autoencoder including an encoder that receives input of a state-action sequence and obtains feature vectors and a decoder that receives input of the feature vectors and reconstructs the state-action sequence.

The update unit 222 updates a prototype that is a typical example of the state-action sequence based on the feature vectors extracted by the extracting unit 221 (step S302). The update unit 222 may store the updated result into a storage device or the like.

Thus, the learning apparatus 200 includes the extracting unit 221 and the update unit 222. According to such a configuration, the extracting unit 221 can perform feature vector extraction using a mechanism to distribute feature vectors on a feature space. The update unit 222 can update a prototype that is a typical example of the state-action sequence based on the feature vectors extracted by the extracting unit 221. Consequently, it is possible to distribute prototypes, thereby reducing the possibility of selecting only a specific prototype during inference. As a result, for example, when assisting on various decision-making by inferring an action corresponding to a state by machine learning, it is possible to enable more appropriate assistance.

The learning apparatus 200 described above can be enabled by incorporating a predetermined program into an information processing apparatus such as the learning apparatus 200. To be specific, a program as another aspect of the present disclosure is a program for causing an information processing apparatus to enable processes to perform feature vector extraction using a mechanism to distribute feature vectors on a feature space in response to input of a state-action sequence including at least one combination of state and action, and update a prototype that is a typical example of the state-action sequence based on the extracted feature vectors.

Further, a learning method executed by the information processing apparatus such as the learning apparatus 200 described above is a method that is executed by the information processing apparatus and includes extracting feature vectors by using a mechanism to distribute feature vectors on a feature space in response to input of the state-action sequence including at least one combination of state and action, and updating a prototype that is a typical example of the state-action sequence based on the extracted feature vectors.

Since a program, a computer-readable recording medium with a program recorded or a learning method that has the above configuration exert the same action and effect as the learning apparatus 200 described above, the abovementioned object of the present disclosure can be achieved.

Further, the inference apparatus 300 is an information processing apparatus that performs inference using a prototype learned by the learning apparatus 200. The hardware configuration of the inference apparatus 300 may be the same as that of the learning apparatus 200 illustrated in FIG. 18. Further, the inference apparatus 300 can implement functions as an acquiring unit 321, an inference unit 322, and an output unit 323 shown in FIG. 21 by acquisition and execution of the programs by the CPU.

The acquiring unit 321 acquires a prototype that has been learned using a mechanism to distribute feature vectors on a feature space, in accordance with a state to be an inference target. For example, the prototype may be learned by the learning apparatus 200 described above.

The inference unit 322 infers an action based on the state to be the inference target and the prototype acquired by the acquiring unit 321. For example, the inference unit 322 may infer an action in response to input of the state to be the inference target and the prototype acquired by the acquiring unit 321 into a model that has learned in advance.

The output unit 323 outputs the action inferred by the inference unit 322 and the prototype used during the inference.

Such an inference apparatus 300 can also achieve the object of the present disclosure described above in the same manner as the learning apparatus 200 and so forth.

### <Supplementary Notes>

The whole or part of the example embodiments disclosed above can be described as the following supplementary notes. Hereinafter, the overview of the configurations of an information processing apparatus and the like in the present disclosure will be described. However, the present disclosure is not limited to the following configurations.

### (Supplementary Note 1)

A learning apparatus comprising:
an extracting unit configured to perform extraction of a feature vector using a mechanism to distribute the feature vector on a feature space in response to input of a state-action sequence including at least one combination of state and action; and
an update unit configured to update a prototype, which is a typical example of the state-action sequence, based on the feature vector extracted by the extracting unit.

### (Supplementary Note 2)

The learning apparatus according to supplementary note 1, wherein
the extracting unit has a mechanism of an autoencoder including an encoder that receives input of the state-action sequence and obtains the feature vector and a decoder that receives input of the feature vector and reconstructs the state-action sequence.

### (Supplementary Note 3)

The learning apparatus according to supplementary note 2, wherein
the extracting unit is configured to extract the feature vector from the state-action sequence by calculating a latent variable in response to input of the state-action sequence.

### (Supplementary Note 4)

The learning apparatus according to supplementary note 2, wherein
the extracting unit uses a variational autoencoder (VAE) as the autoencoder.

### (Supplementary Note 5)

The learning apparatus according to supplementary note 4, wherein
the update unit is configured to update the prototype by solving equations shown by Formulas 15 and 16,

$${L}_{emb} = {\sum }_{m = 1}^{M} {min}_{k = 1}^{K} {D}_{KL} ( 𝒩 ( {μ}_{{v}_{{m}^{′}} : {v}_{m}} , {σ}_{{v}_{{m}^{′}} : {v}_{m}}^{2} I ) ‖ 𝒩 ( {o}_{μ k} , {o}_{σ k}^{2} I ) ) \qquad [ Formula 15 ]$$

$$[ Formula 16 ]$$

$${L}_{option} = {λ}_{1} * {\sum }_{i = 1}^{K} {min}_{m = 1}^{M} {D}_{KL} ( 𝒩 ( {o}_{μ k} , {o}_{σ k}^{2} I ) ‖ 𝒩 ( {μ}_{{v}_{{m}^{′}} : {v}_{m}} , {σ}_{{v}_{{m}^{′}} : {v}_{m}}^{2} I ) ) + {λ}_{2} * {\sum }_{i = 1}^{K} {\sum }_{j = i + 1}^{K} max ( 0 , {d}_{min} - {D}_{JS} ( 𝒩 ( {o}_{μ i} , {o}_{σ i}^{2} I ) ‖ 𝒩 ( {o}_{μ j} , {o}_{σ j}^{2} I ) ) )$$

### (Supplementary Note 6)

The learning apparatus according to supplementary note 1, wherein
the prototype is data used when inferring an action using a state to be inference target.

### (Supplementary Note 7)

The learning apparatus according to supplementary note 1, further comprising:
a selecting unit configured to select an option to be subgoal for each state included in the state-action sequence; and
a dividing unit configured to divide the state-action sequence into one or a plurality of segments based on the option selected by the selecting unit, wherein
the extracting unit is configured to perform extraction of the feature vector in response to input of the segment.

### (Supplementary Note 8)

The learning apparatus according to supplementary note 7, wherein
the dividing unit is configured to divide the state-action sequence for each set of columns in which the option selected by the selecting unit is consecutive in the state-action sequence.

### (Supplementary Note 9)

The learning apparatus according to supplementary note 1, further comprising:
a selecting unit configured to select an option to be subgoal for a state to be inference target;
an acquiring unit configured to acquire the prototype based on the option selected by the selecting unit;
an inference unit configured to infer an action based on the state to be inference target and the prototype acquired by the acquiring unit; and
an output unit configured to output the action inferred by the inference unit and the prototype used in inference.

### (Supplementary Note 10)

The learning apparatus according to supplementary note 1, wherein
the extracting unit is configured to perform extraction of the feature vector using a machine-learned autoencoder, the learning apparatus further comprising:
a selecting unit configured to select an option to be subgoal for a state to be inference target;
an acquiring unit configured to acquire the prototype based on the option selected by the prototype selecting unit;
an inference unit configured to infer an action for user's decision-making based on the state to be inference target and the prototype acquired by the acquiring unit; and
an output unit configured to output the action inferred by the inference unit and the prototype used in inference.

### (Supplementary Note 11)

The learning apparatus according to supplementary note 2, wherein
the extracting unit uses a machine-learned variational autoencoder (VAE) as the autoencoder, the learning apparatus further comprising:
a selecting unit configured to select an option to be subgoal for a state to be inference target;
an acquiring unit configured to acquire the prototype based on the option selected by the selecting unit;
an inference unit configured to infer an action for user's decision-making based on the state to be inference target and the prototype acquired by the acquiring unit; and
an output unit configured to output the action inferred by the inference unit and the prototype used in inference.

### (Supplementary Note 12)

A learning method by an information processing apparatus, the learning method comprising:
performing extraction of a feature vector using a mechanism to distribute the feature vector on a feature space in response to input of a state-action sequence including at least one combination of state and action; and
updating a prototype, which is a typical example of the state-action sequence, based on the extracted feature vector.

### (Supplementary Note 12-1)

The learning method according to supplementary note 12, comprising
when performing extraction of the feature vector, performing extraction of the feature vector using a mechanism of an autoencoder including an encoder that receives input of the state-action sequence and obtains the feature vector and a decoder that receives input of the feature vector and reconstructs the state-action sequence.

### (Supplementary Note 12-2)

The learning method according to supplementary note 12-1, comprising
when performing extraction of the feature vector, performing extraction of the feature vector using a variational autoencoder (VAE) as the autoencoder.

### (Supplementary Note 12-3)

The learning method according to supplementary note 12-2, comprising
when performing extraction of the feature vector, extracting the feature vector from the state-action sequence by calculating a latent variable in response to input of the state-action sequence.

### (Supplementary Note 12-4)

The learning method according to supplementary note 12-2, comprising
updating the prototype by solving equations shown by Formulas 17 and 18,

$${L}_{emb} = {\sum }_{m = 1}^{M} {min}_{k = 1}^{K} {D}_{KL} ( 𝒩 ( {μ}_{{v}_{{m}^{′}} : {v}_{m}} , {σ}_{{v}_{{m}^{′}} : {v}_{m}}^{2} I ) ‖ 𝒩 ( {o}_{μ k} , {o}_{σ k}^{2} I ) ) \qquad [ Formula 17 ]$$

$$[ Formula 18 ]$$

$${L}_{option} = {λ}_{1} * {\sum }_{i = 1}^{K} {min}_{m = 1}^{M} {D}_{KL} ( 𝒩 ( {o}_{μ k} , {o}_{σ k}^{2} I ) ‖ 𝒩 ( {μ}_{{v}_{{m}^{′}} : {v}_{m}} , {σ}_{{v}_{{m}^{′}} : {v}_{m}}^{2} I ) ) + {λ}_{2} * {\sum }_{i = 1}^{K} {\sum }_{j = i + 1}^{K} max ( 0 , {d}_{min} - {D}_{JS} ( 𝒩 ( {o}_{μ i} , {o}_{σ i}^{2} I ) ‖ 𝒩 ( {o}_{μ j} , {o}_{σ j}^{2} I ) ) )$$

### (Supplementary Note 12-5)

The learning method according to supplementary note 12, wherein
the prototype is data used when inferring an action using a state to be inference target.

### (Supplementary Note 12-6)

The learning method according to supplementary note 12, further comprising:
selecting an option to be subgoal for each state included in the state-action sequence;
dividing the state-action sequence into one or a plurality of segments based on the selected option; and
when performing extraction of the feature vector, performing extraction of the feature vector in response to input of the segment.

### (Supplementary Note 12-7)

The learning method according to supplementary note 12-6, comprising
when dividing the state-action sequence, dividing the state-action sequence for each set of columns in which the selected option is consecutive in the state-action sequence.

### (Supplementary Note 12-8)

The learning method according to supplementary note 12, further comprising:
selecting an option to be subgoal for a state to be inference target;
acquiring the prototype based on the selected option;
inferring an action based on the state to be inference target and the acquired prototype; and
outputting the inferred action and the prototype used in inference.

### (Supplementary Note 13)

A non-transitory computer-readable recording medium with a program recorded thereon, the program comprising instructions for causing an information processing apparatus to enable processes to:
perform extraction of a feature vector using a mechanism to distribute the feature vector on a feature space in response to input of a state-action sequence including at least one combination of state and action; and
update a prototype, which is a typical example of the state-action sequence, based on the extracted feature vector.

### (Supplementary Note 13-1)

The recording medium with the program recorded thereon according to supplementary note 13, wherein
when performing extraction of the feature vector, extraction of the feature vector is performed using a mechanism of an autoencoder including an encoder that receives input of the state-action sequence and obtains the feature vector and a decoder that receives input of the feature vector and reconstructs the state-action sequence.

### (Supplementary Note 13-2)

The recording medium with the program recorded thereon according to supplementary note 13-1, wherein
when performing extraction of the feature vector, extraction of the feature vector is performed using a variational autoencoder (VAE) as the autoencoder.

### (Supplementary Note 13-3)

The recording medium with the program recorded thereon according to supplementary note 13-2, wherein
when performing extraction of the feature vector, the feature vector is extracted from the state-action sequence by calculating a latent variable in response to input of the state-action sequence.

### (Supplementary Note 13-4)

The recording medium with the program recorded thereon according to supplementary note 13-2, wherein
the prototype is updated by solving equations shown by Formulas 19 and 20,

$${L}_{emb} = {\sum }_{m = 1}^{M} {min}_{k = 1}^{K} {D}_{KL} ( 𝒩 ( {μ}_{{v}_{{m}^{′}} : {v}_{m}} , {σ}_{{v}_{{m}^{′}} : {v}_{m}}^{2} I ) ‖ 𝒩 ( {o}_{μ k} , {o}_{σ k}^{2} I ) ) \qquad [ Formula 19 ]$$

$$[ Formula 20 ]$$

$${L}_{option} = {λ}_{1} * {\sum }_{i = 1}^{K} {min}_{m = 1}^{M} {D}_{KL} ( 𝒩 ( {o}_{μ k} , {o}_{σ k}^{2} I ) ‖ 𝒩 ( {μ}_{{v}_{{m}^{′}} : {v}_{m}} , {σ}_{{v}_{{m}^{′}} : {v}_{m}}^{2} I ) ) + {λ}_{2} * {\sum }_{i = 1}^{K} {\sum }_{j = i + 1}^{K} max ( 0 , {d}_{min} - {D}_{JS} ( 𝒩 ( {o}_{μ i} , {o}_{σ i}^{2} I ) ‖ 𝒩 ( {o}_{μ j} , {o}_{σ j}^{2} I ) ) )$$

### (Supplementary Note 13-5)

The recording medium with the program recorded thereon according to supplementary note 13, wherein
the prototype is data used when inferring an action using a state to be inference target.

### (Supplementary Note 13-6)

The recording medium with the program recorded thereon according to supplementary note 13, the program comprising instructions for causing the information processing apparatus to enable processes to:
select an option to be subgoal for each state included in the state-action sequence; and
divide the state-action sequence into one or a plurality of segments based on the selected option, wherein
when performing extraction of the feature vector, extraction of the feature vector is performed in response to input of the segment.

### (Supplementary Note 13-7)

The recording medium with the program recorded thereon according to supplementary note 13-6, wherein
when dividing the state-action sequence, the state-action sequence is divided for each set of columns in which the selected option is consecutive in the state-action sequence.

### (Supplementary Note 13-8)

The recording medium with the program recorded thereon according to supplementary note 13, the program comprising instructions for causing the information processing apparatus to enable processes to:
select an option to be subgoal for a state to be inference target;
acquire the prototype based on the selected option;
infer an action based on the state to be inference target and the acquired prototype; and
output the inferred action and the prototype used in inference.

### (Supplementary Note 14)

An inference apparatus comprising:
an acquiring unit configured to acquire a prototype learned using a mechanism to distribute a feature vector on a feature space in accordance with a state to be inference target;
an inference unit configured to infer an action based on the state to be inference target and the prototype acquired by the acquiring unit; and
an output unit configured to output the action inferred by the inference unit and the prototype used in inference.

The program described in the above example embodiments and supplementary notes is stored in a storage device or recorded on a computer-readable recording medium.

For example, the recording medium is a portable medium such as a flexible disk, an optical disk, aa magneto-optical disk, and a semiconductor memory.

Although the present disclosure has been described above with reference to the above example embodiments, the present disclosure is not limited to the example embodiments described above. The configuration and details of the present disclosure can be changed in a variety of ways that those skilled in the art can understand within the scope of the present disclosure. Then, each of the example embodiments can be combined with the other example embodiment as necessary.

### REFERENCE SIGNS LIST

100 inference apparatus
110 acquiring unit
111 state history database
120 option selecting unit
130 state-action sequence dividing unit
140 feature extracting unit
150 prototype update unit
160 prototype database
170 prototype acquiring unit
180 action inference unit
190 output unit
200 learning apparatus
201 CPU
202 ROM
203 RAM
204 programs
205 storage device
206 drive device
207 communication interface
208 input/output interface
209 bus
210 recording medium
21 communication network
221 extracting unit
222 update unit
300 inference apparatus
321 acquiring unit
322 inference unit
323 output unit

What is claimed is:

1. A learning apparatus comprising:
at least one memory storing processing instructions; and
at least one processor configured to execute the processing instructions to:
perform extraction of a feature vector using a mechanism to distribute the feature vector on a feature space in response to input of a state-action sequence including at least one combination of state and action; and
update a prototype, which is a typical example of the state-action sequence, based on the extracted feature vector.

2. The learning apparatus according to claim 1, wherein
a mechanism of an autoencoder including an encoder that receives input of the state-action sequence and obtains the feature vector and a decoder that receives input of the feature vector and reconstructs the state-action sequence is included.

3. The learning apparatus according to claim 2, wherein
a variational autoencoder (VAE) is used as the autoencoder.

4. The learning apparatus according to claim 3, wherein the at least one processor is configured to execute the processing instructions to
extract the feature vector from the state-action sequence by obtaining mean and variance in response to input of the state-action sequence and calculating a latent variable.

5. The learning apparatus according to claim 3, wherein the at least one processor is configured to execute the processing instructions to
update the prototype by solving equations shown by Formulas 1 and 2,
$${L}_{emb} = {\sum }_{m = 1}^{M} {min}_{k = 1}^{K} {D}_{KL} ( 𝒩 ( {μ}_{{v}_{{m}^{′}} : {v}_{m}} , {σ}_{{v}_{{m}^{′}} : {v}_{m}}^{2} I ) ‖ 𝒩 ( {o}_{μ k} , {o}_{σ k}^{2} I ) ) \qquad [ Formula 1 ]$$
$$[ Formula 2 ]$$
$${L}_{option} = {λ}_{1} * {\sum }_{i = 1}^{K} {min}_{m = 1}^{M} {D}_{KL} ( 𝒩 ( {o}_{μ k} , {o}_{σ k}^{2} I ) ‖ 𝒩 ( {μ}_{{v}_{{m}^{′}} : {v}_{m}} , {σ}_{{v}_{{m}^{′}} : {v}_{m}}^{2} I ) ) + {λ}_{2} * {\sum }_{i = 1}^{K} {\sum }_{j = i + 1}^{K} max ( 0 , {d}_{min} - {D}_{JS} ( 𝒩 ( {o}_{μ i} , {o}_{σ i}^{2} I ) ‖ 𝒩 ( {o}_{μ j} , {o}_{σ j}^{2} I ) ) )$$

6. The learning apparatus according to claim 1, wherein
the prototype is data used when inferring an action using a state to be inference target.

7. The learning apparatus according to claim 1, the at least one processor is configured to execute the processing instructions to:
select an option to be subgoal for each state included in the state-action sequence; and
divide the state-action sequence into one or a plurality of segments based on the selected option, wherein
extraction of the feature vector is performed in response to input of the segment.

8. The learning apparatus according to claim 7, wherein the at least one processor is configured to execute the processing instructions to
divide the state-action sequence for each set of columns in which the selected option is consecutive in the state-action sequence.

9. The learning apparatus according to claim 1, wherein the at least one processor is configured to execute the processing instructions to:
select an option to be subgoal for a state to be inference target;
acquire the prototype based on the selected option;
infer an action based on the state to be inference target and the acquired prototype; and
output the inferred action and the prototype used in inference.

10. The learning apparatus according to claim 1, wherein the at least one processor is configured to execute the processing instructions to:
perform extraction of the feature vector using a machine-learned autoencoder;
select an option to be subgoal for a state to be inference target;
acquire the prototype based on the selected option;
infer an action for user's decision-making based on the state to be inference target and the acquired prototype; and
output the inferred action and the prototype used in inference.

11. The learning apparatus according to claim 2, wherein:
a machine-learned variational autoencoder (VAE) is used as the autoencoder; and
the at least one processor is configured to execute the processing instructions to:
select an option to be subgoal for a state to be inference target;
acquire the prototype based on the selected option;
infer an action for user's decision-making based on the state to be inference target and the acquired prototype; and
output the inferred action and the prototype used in inference.

12. A learning method by an information processing apparatus, the learning method comprising:
performing extraction of a feature vector using a mechanism to distribute the feature vector on a feature space in response to input of a state-action sequence including at least one combination of state and action; and
updating a prototype, which is a typical example of the state-action sequence, based on the extracted feature vector.

13. (canceled)

14. An inference apparatus comprising:
at least one memory storing processing instructions; and
at least one processor configured to execute the processing instructions to:
acquire a prototype learned using a mechanism to distribute a feature vector on a feature space in accordance with a state to be inference target;
infer an action based on the state to be inference target and the acquired prototype; and
output the inferred action and the prototype used in inference.
